(19) United States
(12) Patent Application Publication
(10) Pub. No.: US 2020/0382518 A1
(43) Pub. Date: Dec. 3, 2020

(54) SECURE CONTAINER NETWORKING

(71) Applicant: Abacus Verte, Inc., St. Helena, CA (US)

(72) Inventor: Marta Spegman-Lopez Venture, Kingston, NY (US)

(21) Appl. No.: 16/423,101

(22) Filed: May 27, 2019

(51) Int. Cl. H04L 29/06

(52) U.S. Cl. CPC H04L 63/107; H04L 63/20

(57) ABSTRACT

Secure container networking can include detecting a placement of an item into a physically secure structure of a networked secure container; downloading a security policy pertaining to the item via a public network; and enforcing the security policy using a software-controlled lock that controls access to the item inside the physically secure structure.

### BACKGROUND

Certain items in a stream of commerce can be subject of restrictions on handling, custody, and transport. For example, tightly regulated items such as controlled substances, firearms, etc., can be subject to strict custody and tracking rules.

Digital tracking can be employed to document compliance with item restrictions. For example, bar code readers and the like can be used to sample digital tracking data for an item at various locations along its shipping route. The sampled digital tracking data for an item can be uploaded to a tracking database. The tracking database can provide a digital view of custody and movement of the item in terms of when and where the tracking data for the item was sampled.

### SUMMARY

In general, in one aspect, the invention relates to a networked secure container. A networked secure container according to the invention can include: a physically secure structure for holding an item and having a software-controlled access mechanism for enabling and disabling access to the item when the item is inside the physically secure structure; and an embedded computing mechanism capable of communication via a public network, the embedded computing mechanism downloading a security policy pertaining to the item via the public network and enforcing the security policy using the software-controlled access mechanism.

In general, in another aspect, the invention relates to a method for secure container networking. The method can include detecting a placement of an item into a physically secure structure of a networked secure container; downloading a security policy pertaining to the item via a public network; and enforcing the security policy using a software-controlled lock that controls access to the item inside the physically secure structure.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates networked secure container in one or more embodiments.

FIG. 2 shows how a networked secure container uploads a security report that includes a set of parameters describing an access to an item held in the networked secure container.

FIGS. 3A-3C illustrate an example of transporting a networked secure container across a series of jurisdictions each of which has its own unique regulatory policy pertaining to an item in the networked secure container.

FIG. 4 illustrates a computing mechanism embedded in a networked secure container in one or more embodiments.

FIG. 5 illustrates a method for secure container networking in one or more embodiments.

FIG. 6 illustrates a computing system upon which portions of a secure container manager can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

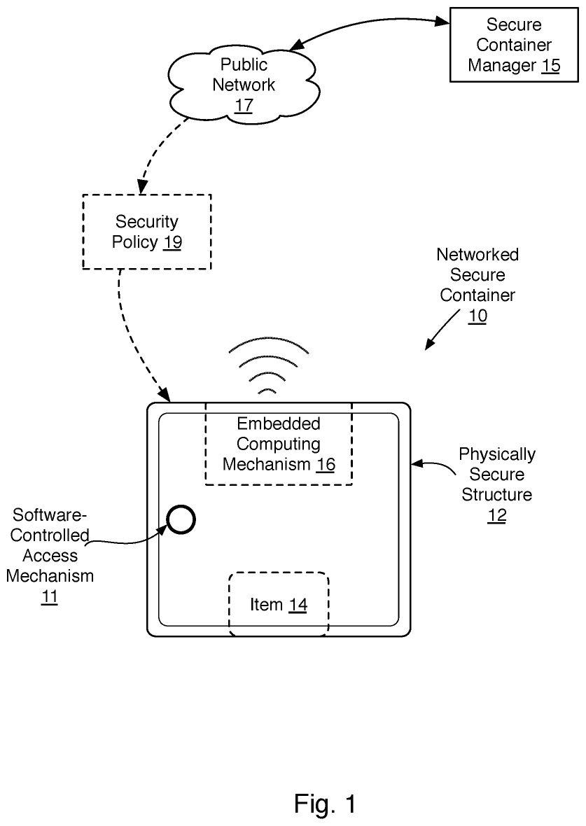

FIG. 1 illustrates a networked secure container 10 in one or more embodiments, The networked secure container 10 includes a physically secure structure 12 for holding an item 14, and further includes a software-controlled access mechanism 11 for enabling and disabling access to the item 14 when the item 14 is inside the physically secure structure 12.

The item 14 can be an item subject to custody, handling, transport restrictions. For example, the item 14 can be a package containing highly regulated goods such as drugs or other controlled substances, firearms, etc., or unique personal items, high-value items, insured items, storage devices containing confidential information, etc.

The physically secure structure 12 can include a steel frame with a steel door and a robust locking mechanism. The physically secure structure 12 can be integrated into a bank or tower arrangement of similar structures adapted for placement inside a cargo area of a vehicle.

The networked secure container 10 includes an embedded computing mechanism 16 capable of communication via a public network 17. The embedded computing mechanism 16 downloads a security policy 19 pertaining to the item 14 via the public network 17 and then enforces the security policy 19 using the software-controlled access mechanism 11. The security policy 19 can specify when, where, who can access the item 14 from the physically secure structure 12.

In one or more embodiments, the security policy 19 specifies a set of conditions under which the item 14 can be accessed from the physically secure structure 12. The conditions specified in the security policy 19 can pertain to physical location, e.g., geographic areas, map coordinates, jurisdictions, border crossings, buildings, addresses, etc. The conditions specified in the security policy 19 can pertain to personnel, agencies, officials, etc. The conditions specified in the security policy 19 can pertain to time.

For example, the security policy 19 can specify that the item 14 can only be accessed at a specified physical address, e.g., a shipping destination, and in response the embedded computing mechanism 16 disables unlocking via the software-controlled access mechanism 11 unless the current location of the networked secure container 10 matches the physical address specified in the security policy 19. Likewise, the security policy 19 can specify that the item 14 can only be accessed by specified personnel, e.g., personnel identified by badge scan, and in response the computing mechanism 16 disables unlocking via the software-controlled access mechanism 11 unless the appropriate personnel are identified by the networked secure container 10.

In one or more embodiments, the networked secure container 10 downloads the security policy 19 from a secure container manager 15 via the public network 17 when item 14 is placed into the physically secure structure 12. For example, the embedded computing mechanism 16 can download the security policy 19 when the item 14 is scanned into the physically secure structure 12, e.g., using bar code reader, RFID, etc.

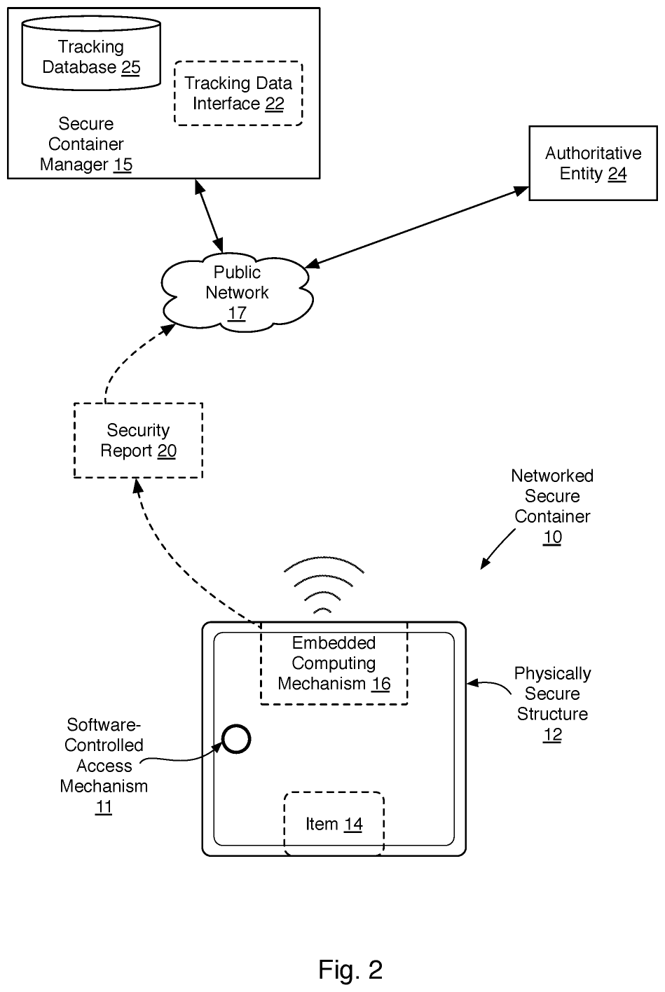

FIG. 2 shows how the networked secure container 10 uploads a security report 20. The security report 20 includes a set of parameters describing a security state of the item 14 held in the physically secure structure 12. The security report 20 can specify when the item 14 was accessed, where it was accessed, and who accessed it from the physically secure structure 12. The security report 20 can indicate whether or not the item is currently accessible and under what conditions. The security report 20 can include a set of tracking data for the networked secure container 10.

In one or more embodiments, the security policy 19 specifies a set of conditions that cause the networked secure container 10 to upload the security report 20. For example, the security policy 19 can cause the networked secure container 10 to upload a security report whenever a border is crossed, or when specified locations are reached, or when specified jurisdictions are entered.

The networked secure container 10 can upload the security report 20 to the secure container manager 15 or to an authoritative entity 24 via the public network 17. In one or more embodiments, the secure container manager 15 logs the security report 20 in a tracking database 25 and provides a tracking data interface 22 that enables the authoritative entity 24 access the tracking database 22 via the public network 17.

The authoritative entity 24 can be a relevant government regulator for the item 14, a law enforcement agency, a business administrative agency, e.g., for a shipping company etc.

In one or more embodiments, the authoritative entity 24 is a government regulator for the item 14 in a relevant jurisdiction, e.g., state, local, or national government. The contents of the security report 20, available directly or from the tracking database 25 can enable a regulator to verify, e.g., that the item 14 is not accessible in their jurisdiction or verify that the handling of the item 14 adhered to the appropriate restrictions within their jurisdiction.

In one or more embodiments, the authoritative entity 24 is an insurer of the item 14 and the contents of the security report 20 can enable the insurer to verify that handling and movements of the item 14 have not violated an insurance contract pertaining to the item 14.

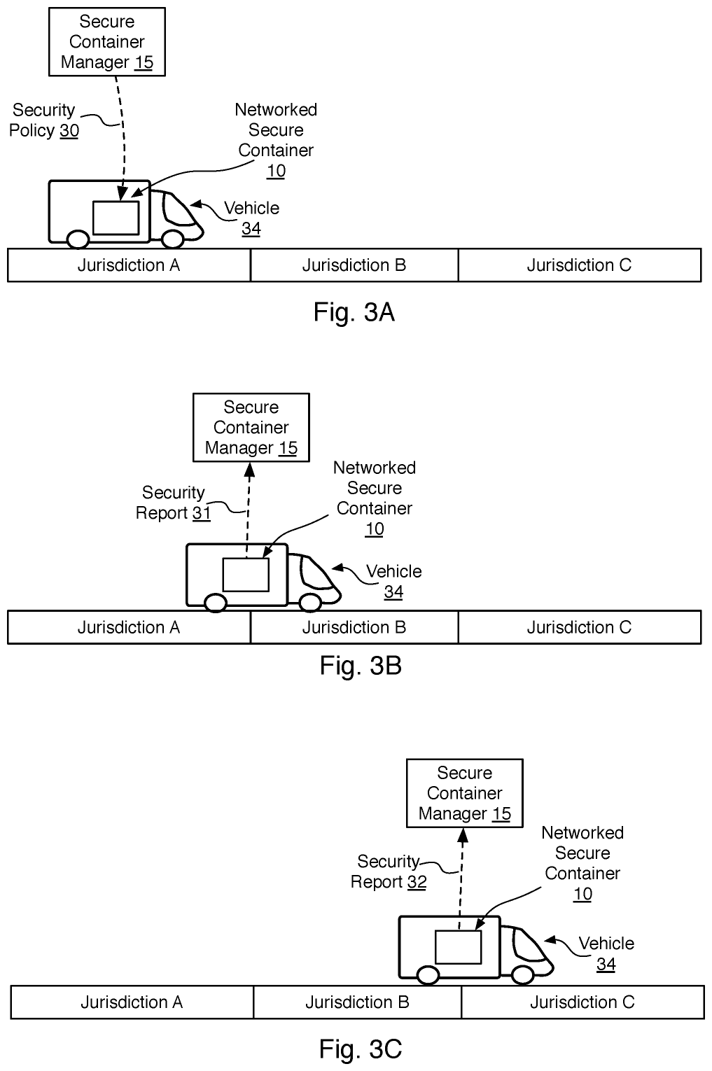

FIGS. 3A-3B illustrate an example in which a vehicle 34 transports the networked secure container 10 containing the item 14 across a series of jurisdictions, A-C, each of which has its own unique regulatory policy pertaining to the item 14. For example, the jurisdiction A may allow relatively liberal access to the item 14, the jurisdiction B may restrict access to certain licensed personnel, and the jurisdiction C may prohibit the item 14 altogether.

FIG. 3A shows the vehicle 34 at the start of a trip across jurisdictions A-C, where the secure container manager 15 downloads a security policy 30 to the networked secure container 10. The security policy 30 specifies what security policy is to be enforced in each jurisdiction A-C. For example, the security policy for when the vehicle 34 is in jurisdiction A may specify unrestricted access to the item 14, limited only by normal shipping security, the security policy for when the vehicle 34 is in jurisdiction B may involve restricting access to the item 14 to identified personnel only, and the security policy for when the vehicle 34 is in jurisdiction C may require complete lock out until the vehicle 34 leaves jurisdiction C.

FIG. 3B shows the vehicle crossing the border between jurisdictions A and B. The networked secure container 10 detects the border crossing between jurisdictions A and B and, in accordance with the security policy 30, services the rules of jurisdiction B and uploads a security report 31 to the secure container manager 15.

FIG. 3C shows the vehicle 34 crossing the border between jurisdictions B and C. The networked secure container 10 detects the border crossing between jurisdictions B and C and, in accordance with the security policy 30, services the access rules of jurisdiction C by locking out all accesses to the item 14 and uploading a security report 32 to the secure container manager 15.

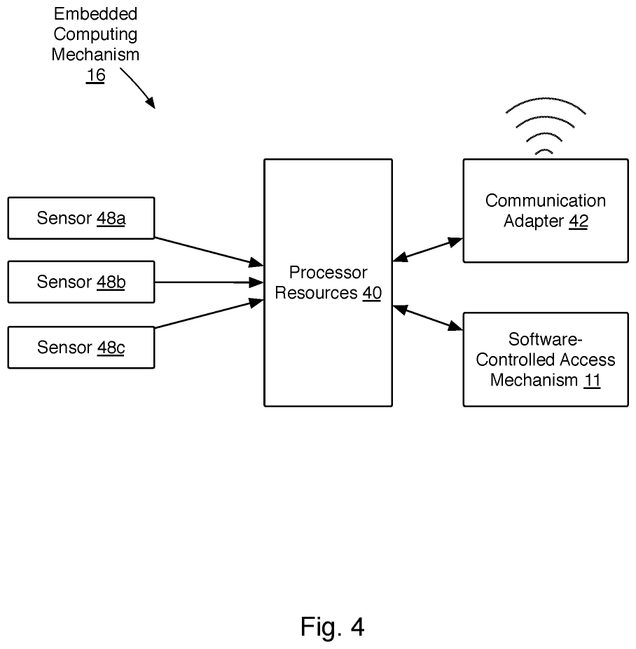

FIG. 4 illustrates the embedded computing mechanism 16 in the networked secure container 10 in one or more embodiments. The embedded computing mechanism 16 includes a set of processor resources 40, e.g., CPU, memory, code, etc. The code can be persistent or downloaded from the secure container manager 15, e.g., a new set of code for a new security policy.

The embedded computing mechanism 16 includes a communication adapter 42 for communicating with the secure container manager 15 via the public network 17. The communication adapter 42 can enable communication directly with the secure container manager 15 via the public network 17 using, e.g., cellular communication, or can enable indirect communication on the public network 17 using, e.g., a local network or near field communication channel in a vehicle in which the networked secure container 10 is installed.

The embedded computing mechanism 16 includes a variety of sensors 48a-c that provide a variety of measurements pertaining to enforcing the security policies downloaded to networked secure container 10 and for uploading security reports. For example, the sensors 48a-c can include sensors that sample location of the networked secure container 10, e.g., GPS coordinates, map coordinates, cell tower location, border crossing indicators, etc., sensors that identify personnel who access the networked secure container 10, e.g., badge readers, facial recognition, etc., as well as sensors that read package identifiers, e.g., barcode, RFID, printed text, labels, etc., for the item 14, etc.

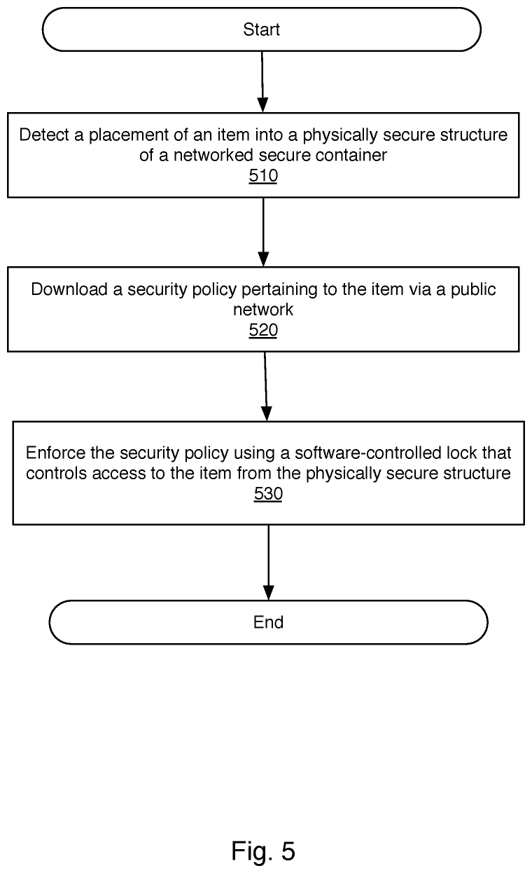

FIG. 5 illustrates a method for secure container networking in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 5 should not be construed as limiting the scope of the invention.

At step 510, a placement of an item into a physically secure structure of a networked secure container is detected. The placement of the item can be detected using sensors in the networked secure container, e.g., barcode scanner, RFID reader, near field communication, etc.

At step 520, a security policy pertaining to the item is downloaded via a public network. The security policy can be downloaded from a container manager for the networked secure container. The security policy can specify a set of access and reporting conditions for the item.

At step 530, the downloaded security policy is enforced using a software-controlled lock that controls access to the item in the physically secure structure. The software-controlled lock can be controlled in response to the when, where, and who conditions specified in the security policy.

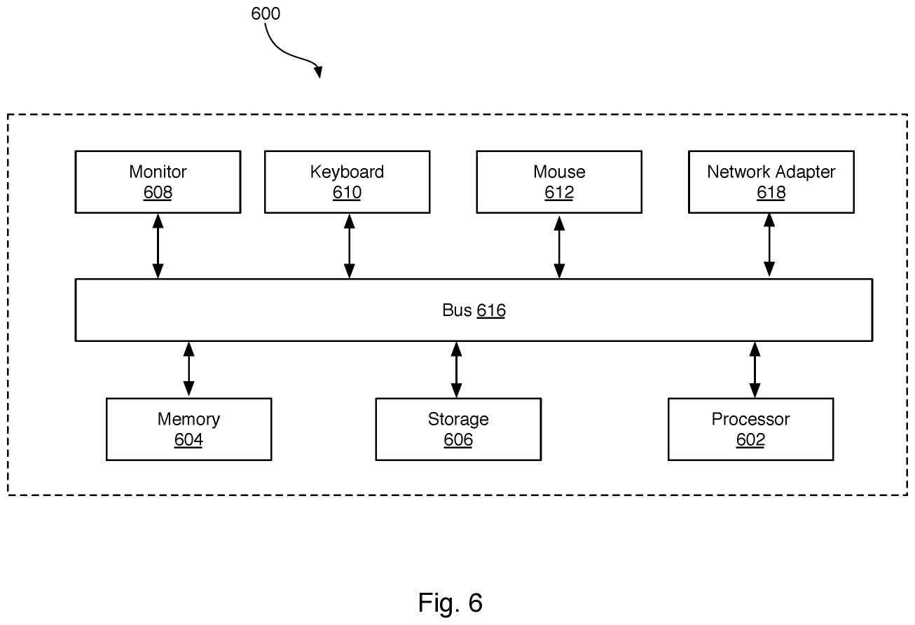

FIG. 6 illustrates a computing system 600 upon which portions of the secure container manager 15 can be implemented. The computing system 600 includes one or more computer processor(s) 602, associated memory 604 (e.g., random access memory (RAM), cache memory, flash memory, etc.), one or more storage device(s) 606 (e.g., a hard disk, an optical drive such as a compact disk (CD) drive or digital versatile disk (DVD) drive, a flash memory stick, etc.), a bus 616, and numerous other elements and functionalities.

The computer processor(s) 602 may be an integrated circuit for processing instructions. For example, the computer processor(s) may be one or more cores or micro-cores of a processor. The computing system 600 may also include one or more input device(s), e.g., a touchscreen, keyboard 610, mouse 612, microphone, touchpad, electronic pen, or any other type of input device. Further, the computing system 600 may include one or more monitor device(s) 608, such as a screen (e.g., a liquid crystal display (LCD), a plasma display, touchscreen, cathode ray tube (CRT) monitor, projector, or other display device), external storage, input for an electric instrument, or any other output device. The computing system 600 may be connected to, e.g., a local area network (LAN), a wide area network (WAN) such as the Internet, mobile network, or any other type of network) via a network adapter 618.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A networked secure container, comprising:
a physically secure structure for holding an item and having a software-controlled access mechanism for enabling and disabling access to the item when the item is inside the physically secure structure; and
an embedded computing mechanism capable of communication via a public network, the embedded computing mechanism downloading a security policy pertaining to the item via the public network and enforcing the security policy using the software-controlled access mechanism.

2. The networked secure container of claim 1, wherein the security policy specifies when the item can be accessed from the physically secure structure.

3. The networked secure container of claim 1, wherein the security policy specifies where the item can be accessed from the physically secure structure.

4. The networked secure container of claim 1, wherein the security policy specifies who can access the item from the physically secure structure.

5. The networked secure container of claim 1, wherein the embedded computing mechanism downloads the security policy from a secure container manager via the public network when item is placed into the physical secure structure.

6. The networked secure container of claim 1, wherein the embedded computing mechanism uploads to a secure container manager a security report that includes a set of parameters describing an access to the item such that the secure container manager logs the security report in a tracking database and provides a software interface that enables an authoritative entity to access the tracking database via the public network.

7. A method for secure container networking, comprising:
detecting a placement of an item into a physically secure structure of a networked secure container;
downloading a security policy pertaining to the item via a public network; and
enforcing the security policy using a software-controlled lock that controls access to the item inside the physically secure structure.

8. The method of claim 7, wherein enforcing comprises enforcing when the item can be accessed from the physically secure structure.

9. The method of claim 7, wherein enforcing comprises enforcing where the item can be accessed from the physically secure structure.

10. The method of claim 7, wherein enforcing comprises enforcing who can access the item from the physically secure structure.

11. The method of claim 7, further comprising uploading a security report that includes a set of parameters describing an access to the item inside the physically secure structure and logging the security report and generating a software interface that enables an authoritative entity to access the security report via the public network.
